(19) United States
(12) Patent Application Publication
(10) Pub. No.: US 2012/0046020 A1
(43) Pub. Date: Feb. 23, 2012

(54) System and Method for Deactivating Mobile Communication Devices within a Vehicle

(76) Inventor: John Tomasini, Richfield, WI (US)

(21) Appl. No.: 13/213,055

(22) Filed: Aug. 18, 2011

Related U.S. Application Data
(60) Provisional application No. 61/374,860, filed on Aug. 18, 2010.

(51) Int. Cl. H04W 4/04

(52) U.S. Cl. 455/418

(57) ABSTRACT

A system and method of deactivating complete functionality of mobile communication devices while in a moving automobile. The system comprises a series of integrated chips that communicate vehicle status to a universal cell phone mount, which communicates to corresponding cell phones within the vehicle. While the vehicle is in a state of motion or when the transmission is not in ‘Park’, all mobile communication functions are prohibited except that phone placed in the universal mount, which allows hands free and voice entry command via the vehicle sound system. The goal is to reduce the use of cell phones and other mobile devices while operating a motor vehicle, improving roadway safety for all drivers.

### CROSS REFERENCE TO RELATED APPLICATION

This application claims the benefit of U.S. Provisional Application No. 61/374,860 filed on Aug. 18, 2010, entitled “Text Deactivations with Hands-Free Operations.”

### BACKGROUND OF THE INVENTION

1. Field of the Invention

The present invention relates to mobile devices and their use while in a moving automobile. More specifically, the present invention pertains to a system and method of preventing users from actively using their mobile devices while driving or while traveling in a moving vehicle except for those devices secured on a specified mount or holder that allows hands free operation and voice communication via the vehicle sound system.

2. Description of the Prior Art

Operating a motor vehicle requires attention to the roadway and to surrounding traffic. Distractions that draw attention from the task of safely operating a vehicle can result in collisions with other motorists or objects, and can lead to serious injuries. Distractions of particular concern are those that require the operator to remove his or her hands from the steering wheel to complete an ancillary task. These include eating while driving, operating the car radio system or navigation, and most recently using a mobile cellular device while driving. The proliferation of cellular phones has resulted in a marked increase in the number of traffic incidents related to distracted drivers, including those who are texting, searching their phones or actively having a phone conversation while operating a motor vehicle. Many states have outlawed the use of cellular phones without hands free control because of this up rise in related accidents, which in some cases have resulted in serious injuries and deaths. However, there remains a need in the art for a system that enforces this rule universally, and prohibits drivers and passengers from engaging their cell phones without hands free control while in a moving vehicle.

The present invention provides a system that comprises three integrated communication chips. One is mounted within the vehicle and is able to interpret vehicle status from the onboard engine control unit (ECU), including the state of the transmission and whether the vehicle is moving or stationary. The second is imbedded within a cell phone holder, which is mounted within the cabin of the vehicle. The third is integrated into the cell phones within the vehicle. As the vehicle is in motion, or when the vehicle transmission is placed in ‘Drive,’ the first chip communicates to the central, cell phone holder chip. This chip sends a signal to all associated cell phones with integrated chips within the vehicle and places their phones in a state that requires hands free operation. The phone placed on the universal cell phone holder is exempt from this deactivation and hands free operation and voice input is permitted in lieu of hand control. Texting, web surfing and manually dialing numbers is not permitted on all other devices, as this distracts both the eyes and hands of a potential driver away from the task of operating the vehicle. Similar to ‘Airplane Mode’ on most cell phones, the present invention provides a ‘Car Mode’ or ‘Driving Mode’ that deactivates all non-hands free features on cell phones not mounted to a specified universal cell phone mount.

Devices, systems and methods of cell phone tracking and deactivation have been disclosed in the prior art. These prior art patents and publications have familiar design elements and features; however they fail to fully disclose a system that utilizes integrated chips to robustly process the state of a vehicle, place all associated mobile devices in a deactivated state while allowing hands free operation of a particular cell phone placed on a specified mount. The present invention provides a system and method for this task. U.S. Published Patent Application No. 2010/0009629 to Farley describes a system and method of disabling specific cell phone functionality while driving, particularly text messaging, as a safety feature. While moving, the cell phone is being tracked through its cellular grid or via Global Positioning Satellites (GPS). Based on its velocity, when either of these systems determines the cell phone is traveling within a vehicle, specific cell phone functionality is disabled as a safety feature. While the Farley patent describes a similar purpose, its method of disabling functionality differs from the present invention. The present invention requires several integrated chips to communicate vehicle status to corresponding cell phones, as opposed to a broad system that monitors the device velocity through space. While the Farley patent may require less setup or integration, the present invention provides a more robust method of disabling a cell phone.

U.S. Published Patent Application No. 2009/0240464 to Dietz describes a mobile device configured to estimate its own speed through a timing component configure to perform a plurality of Doppler shift measurements on a received timing signal. Based on the estimated speed of the device, if a predetermined threshold has been achieved, the device is considered traveling within a vehicle and deactivates certain functionality. Similar to the Farley patent, the Dietz patent describes a built-in feature of a cellular phone, as opposed to a signal generated from the vehicle itself. The present invention receives signals directly from the onboard ECU to determine whether the device is within a vehicle and whether the vehicle is in motion.

U.S. Published Patent Application No. 2009/0224931, also to Dietz, describes a mobile device configured to disable one function when a predefined threshold has been exceeded, and in particular when a phone is traveling in a vehicle. The Dietz patent describes a safety feature that disables a certain function while the user is driving, which could otherwise serve to distract the user. A notification is displayed on the device relating to the disabled feature, along with override control. Similar to the first Dietz patent and the Farley patent, no vehicle mounted system is in communication with the vehicle to relay a determination as to the vehicle's status. These systems rely on triangulation, GPS coordinates and other algorithms to determine the speed of the mobile device in relation to a threshold velocity.

The present invention is a modification to an existing automobile, or an integration for future vehicles and cell phone devices. The invention works by communicating a vehicle status to a set of cell phones determined to be in proximity and traveling within the same vehicle. These phones have their functionality reduced or disabled based on the vehicle state of motion. When the vehicle is moving or when the transmission is in ‘Drive,’ all associated cell phones are placed in the aforementioned deactivated state. The only device with full operability is one placed on a specific, dash supported phone mount that changes that cell phone's functionality to hand's free operation with voice entry only. Functionalities contemplated for reduction include texting, web surfing, playing games or accessing apps, and other similar attention distracting functions on a device activated by hand and requiring visual attention. The present invention substantially diverges in design elements from the prior art and consequently it is clear that there is a need in the art for an improvement to existing cell phone safety devices for use in a moving vehicle. In this regard the instant invention substantially fulfills these needs.

### SUMMARY OF THE INVENTION

In view of the foregoing disadvantages inherent in the known types of cell phone safety features within a vehicle now present in the prior art, the present invention provides a new cell phone safety feature wherein the same can be utilized for providing convenience for the user when operating a motor vehicle and operating a cellular phone device simultaneously.

It is therefore an object of the present invention to provide a new and improved cell phone safety device that has all of the advantages of the prior art and none of the disadvantages.

It is therefore an object of the present invention to provide a cellular phone safety system and method that prevents users from operating a motor vehicle while simultaneously performing functions on a cellular phone that require both visual and tactic methods of operation.

Another object of the present invention is to provide an integrated system that monitors (1) the state of motion and transmission of an automobile, (2) the proximity of cellular devices to the vehicle cabin to determine whether such devices are being carried therein, and finally (3) the placement of a particular cellular device on a specified mount. The mount switches the particular cell phone to hands free operation only for control and voice input. The mount may further integrate the voice and sound of the device into the vehicle sound system via either Bluetooth or hard-wired technology. All other devices carried in the vehicle are restricted in their functionality, limiting certain features that are distracting and dangerous while operating or riding in a motor vehicle.

Yet another object of the present invention is to provide a method of communication between devices that utilizes an embedded chip to control functionality.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows the two modes of operation for a cellular device while traveling in a motor vehicle, wherein the first view includes a phone not tethered to the specified mount and the second view shows operation of hands-free functionalities of the same phone when placed on the specified mount.

FIG. 2 shows a view that expands on FIG. 1, wherein all cellular phones not connected to the specified mount within a vehicle are restricted in their functionality.

### DETAILED DESCRIPTION OF THE INVENTION

Reference is made herein to the attached drawings. Like reference numerals are used throughout the drawings to depict like or similar elements of the book display device for automobiles. For the purposes of presenting a brief and clear description of the present invention, the preferred embodiment will be discussed as used for controlling cellular phone use while in a motor vehicle using the features and methods taught by the present invention. The drawings are considered for illustrative representation purposes only and should not be considered to be limiting with respect to the present invention.

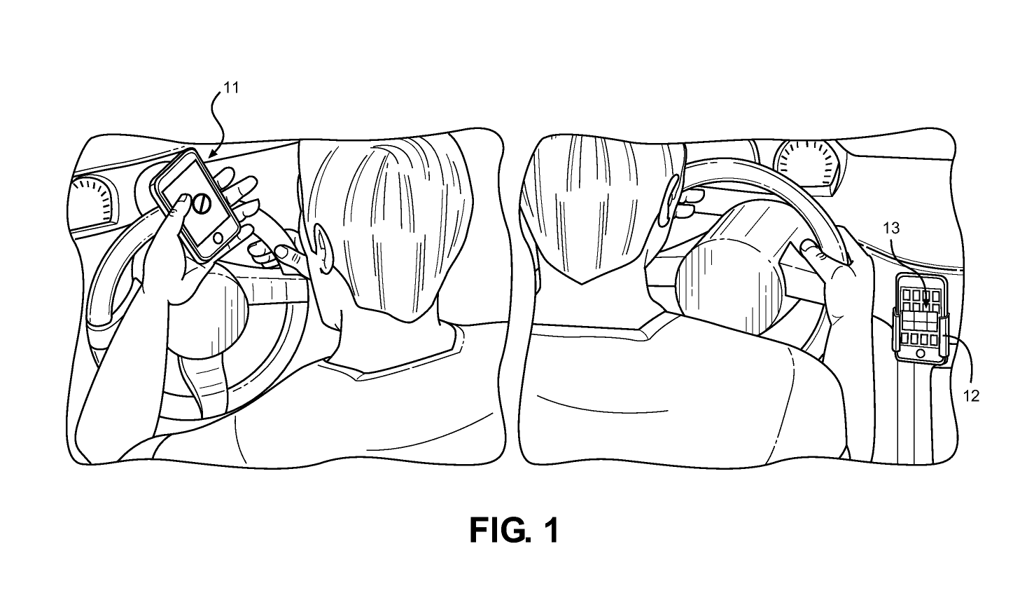

Referring now to FIG. 1, there is shown a view of the present invention in its working form. Two modes of cellular phone operation are depicted within a moving vehicle. The left view shows the present invention functioning on a cellular phone 11 that is detected within the vehicle cabin that is not fixed to the cellular phone mount 12. Utilizing the system and methods of the present invention, a phone 11 not connected to the mount is thereby restricted in its functionality. All functions that require visual or tactile input are deactivated. Once placed on the mount 12, as shown in the figure to the right, the phone 13 returns to full functionality with a limitation that only voice input is active.

The present invention provides a system that utilizes built-in or integrated control within the vehicle, the cellular phones and the cellular phone mount. The control may take the form of an imbedded chip in all three devices, or may take the form of an algorithm preprogrammed into the vehicle engine control unit (ECU) and the cellular phones. The use of an integrated chip requires each device to be manufactured in such a way, while the use of a software algorithm may be downloaded into both technologies. Using the latter, once the cellular phone detects that it is on the cellular phone mount, the appropriate functionality unlocking may commence and voice input may be activated. The present system may locate the cell phones within the vehicle either through the integrated chip hardware or through a similar algorithm that monitors location with respect to the vehicle.

The vehicle status is monitored via the ECU. Upon determination of a vehicle transmission placed in ‘Drive’ or when the vehicle velocity is greater than zero, the system is activated to begin restricted cellular phone activity within the vehicle cabin. Placement of a cellular phone 13 on the mount 12 allows voice input, voice to text and receipt and transmission of phone calls. The mount 12 may further integrate the cellular phone 13 into the electronics of the vehicle, most notably the sound system and a microphone for speech input. This additional functionality is considered an exemplary embodiment of the present invention.

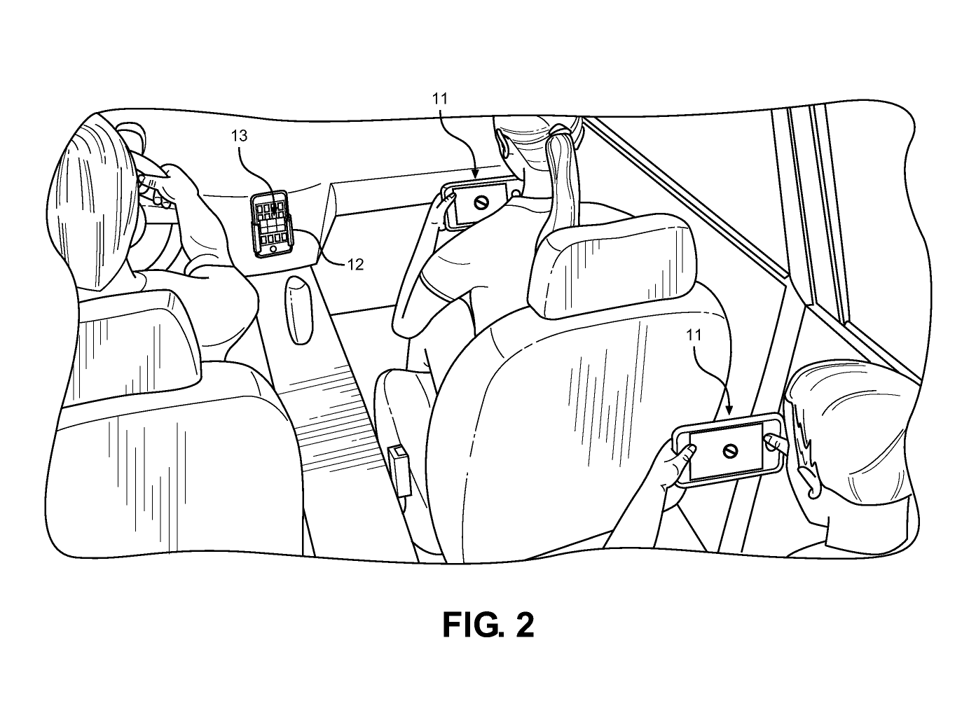

Referring now to FIG. 2, there is shown another view of the present invention system and method in use. Cellular phones 11 not placed on a specified mount 12 are limited in their functionality, while that phone connected to the mount is provided all functionality that is accessible via voice input. The present invention is designed to eliminate the use of text messaging, GPS entries and having phone conversations while manually operating the cellular phone in a vehicle while in motion. When the vehicle is started and left in ‘Park’ for an automatic transmission and in neutral, and not moving for a manual transmission vehicle, a driver may use their cellular phones as they would normally and without interruptions. However, when vehicles are shifted out of ‘Park’ or the vehicle begins moving, manual input functions are disabled for those phones not tethered to the universal mount 12, wherein hands-free operation is allowed only.

The mount 12 utilized in the present invention is intended to be a universal cell phone holder, which can accommodate a wide range of cell phones to facilitate the disclosed system and method of the present invention. Its structure may be adaptable to fit different sized cell phones, while the structural mount itself may telescope for improved ergonomics for the user. Further, the mount provides a means to charge the cell phone while docked on the mount, including a specific plug or connection therefor. Voice input, once the cell phone 13 is placed on the mount 12, is accomplished through the vehicle's onboard sound system, wherein a microphone and set of speakers are utilized to accept voice commands and relay sounds and auditory signals therethrough.

Distractions while driving and items that draw attention away from the operator of a motor vehicle can be a serious hazard to all drivers, and has quickly become a public health concern. The present invention provides a means to reduce these distractions by eliminating the use of cell phones without hands free operation while driving. The goal is to improve roadway safety, reduce vehicular traffic collisions and consequently reduce injuries and deaths as a result of distracted drivers.

With respect to the above description then, it is to be realized that the optimum dimensional relationships for the parts and steps of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A vehicular safety system that restricts cell phone operation to hands free input only, comprising:
a plurality of imbedded hardware chips in (1) a vehicle, (2) within a cellular phone mount and (3) a cellular phone device;
said vehicular chip receives input from said vehicle Engine Control Unit (ECU) to determine a state of said vehicle, including speed and transmission position;
said cellular phone mount chip allows a cellular phone placed thereon to operate in hands-free mode only;
said cellular phone device chip receiving signals from said cellular phone mount that deactivates all non-hands free operation when said cellular phone is not attached to said mount and said vehicle is either moving or in ‘Drive.’

2. A system as in claim 1, wherein said cellular phone mount integrates said cell phone mounted thereon into said vehicle stereo system for improved speaker phone quality and volume.

3. A system as in claim 1, further comprising said cellular phone mount chip calculating a distance to nearby cellular phone device chips to determine if said cellular phones are within said vehicle cabin.

4. A device as in claim 1, wherein said voice input is accomplished through a microphone in said vehicle sound system, while sounds and auditory signals are transmitted through said vehicle sound system speakers.

5. A vehicular safety system that restricts cell phone operation to hands free input only, comprising:
a plurality of software algorithms in (1) a vehicle, (2) within a cellular phone mount chip and (3) a cellular phone device;
said vehicular algorithm receives input from said vehicle Engine Control Unit (ECU) to determine a state of said vehicle, including speed and transmission position;
said cellular phone mount chip allows a cellular phone placed thereon to operate in hands-free mode only;
said cellular phone device algorithm receiving signals from said cellular phone mount that deactivates all non-hands free operation when said cellular phone is not attached to said mount and said vehicle is either moving or in ‘Drive.’

6. A system as in claim 5, wherein said cellular phone mount integrates said cell phone mounted thereon into said vehicle stereo system for improved speaker phone quality and volume.

7. A system as in claim 5, further comprising said cellular phone mount chip calculating a distance to nearby cellular phone devices to determine if said cellular phones are within said vehicle cabin.

8. A method of restricting cell phone operation within a vehicle to hands free input only, comprising:
imbedding a plurality of hardware chips in (1) a vehicle, (2) within a cellular phone mount and (3) a cellular phone device;
sending a signal from said vehicle Engine Control Unit (ECU) to said cellular phone mount chip to relay a state of said vehicle, including speed and transmission position;
sending a signal from said cellular phone mount to said cellular phones within said vehicle to restrict functionally to only any hands-free operation if said vehicle is moving or is in ‘Drive.’
